(19) United States
(12) Patent Application Publication
(10) Pub. No.: US 2009/0106003 A1
(43) Pub. Date: Apr. 23, 2009

(54) SYSTEM, METHOD AND APPARATUS FOR MANAGEMENT OF SIMULATIONS

(75) Inventor: Daniel Lawrence Diehl, Chuluota, FL (US)

Correspondence Address: CAREY, RODRIGUEZ, GREENBERG & PAUL LLP;ATTN: STEVEN M. GREENBERG, ESQ., 950 PENINSULA CORPORATE CIRCLE, SUITE 3020, BOCA RATON, FL, 33487, US

(73) Assignee: UNIVERSAL SYSTEMS AND TECHNOLOGY, INC., Centreville, VA (US)

(21) Appl. No.: 12/257,373

(22) Filed: Oct. 23, 2008

Related U.S. Application Data
(60) Provisional application No. 60/981,865, filed on Oct. 23, 2007.

(51) Int. Cl. G06G 7/60

(52) U.S. Cl. 703/6

(57) ABSTRACT

A method for managing a computer simulation is disclosed. The method includes providing an interface for soliciting input of initialization parameters for generating a training exercise and receiving from the interface initialization parameters entered by a user. The method further includes executing the training exercise defined by the initialization parameters and providing a second interface for soliciting input of execution parameters for managing execution of the training exercise. The method further includes receiving from the second interface execution parameters entered by a user and modifying execution of the training exercise as defined by the execution parameters. The method further includes storing performance data associated with performance of participants during execution of the training exercise and providing a third interface that provides a summary of the performance data.

### CROSS-REFERENCE TO RELATED APPLICATIONS

The present patent application claims priority to U.S. provisional patent application Ser. No. 60/981,865 filed on Oct. 23, 2007 by assignee Universal System & Technology, Inc. U.S. provisional patent application Ser. No. 60/981,865 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

This invention relates to simulations, and more particularly to the planning, support and evaluation of simulations.

### BACKGROUND OF THE INVENTION

Organizations use a variety of training techniques to instill skills into their members. One of the most effective types of training is simulation training. This type of training simulates actual scenarios and allows the participants to undergo a semi-realistic experience while keeping costs low and eliminating or reducing real-life dangers. Computer simulations are the most common type of simulation. A fully virtual computer simulation involves participation by individuals via computer workstations that access a central computer program similar to a multiplayer video game. A semi-virtual computer simulation, otherwise known as a war game, involves a computer program that works in conjunction with actual deployment of individuals and vehicles into a limited area and includes all of the movement and action that takes place during a real scenario but typically without dangers such as live ordinance and ammunition. Multiple Integrated Laser Engagement System (MILES), for example, is a computer-based military training system that provides a realistic battlefield environment for soldiers involved in training exercises.

MILES provides tactical engagement simulation for direct fire force-on-force training using eye-safe laser “bullets.” Each individual and vehicle in the training exercise has a detection system to sense hits and perform casualty assessment. Laser transmitters are attached to each individual and vehicle weapon system and accurately replicate actual ranges and lethality of the specific weapon systems. Combat vehicles, support vehicles and individual solders are instrumented with a GPS receiver for position location determination and a transmitter for sending all recorded data back to central command executing a computer program. All player activity is recorded during an exercise. Position location, and direct and indirect fire event reporting is accomplished through transmitters/receivers.

When considering large scale computer simulations that involve hundreds or thousands of participants and multiple computer simulation programs, large amounts of information must be created, put into action and subsequently evaluated after the simulation has ended. Due to this fact, one aspect of simulation training that requires automation is the planning, design and development of training exercises. This step typically involves high level planning such as defining scenarios, identifying missions and creating simulated events. A subsequent aspect of simulation training that requires automation is the delivery of a training exercise and the management of the exercise during delivery. This step involves the proper execution of the computer simulation by the computer program and the proper management of its varying elements during execution. A final aspect of simulation training that requires automation is the evaluation of the execution of the training exercise. This step involves proper assessment of the behavior of participants in the computer simulation in light of established parameters.

Therefore, a need exists to overcome the problems with the prior art as discussed above, and particularly for a more efficient way for designing, delivering and subsequently evaluating the execution of large scale computer simulation.

### SUMMARY OF THE INVENTION

Briefly, according to an embodiment of the present invention, method for managing a computer simulation is disclosed. The method includes providing an interface for soliciting input of initialization parameters for generating a training exercise and receiving from the interface initialization parameters entered by a user. The method further includes executing the training exercise defined by the initialization parameters and providing a second interface for soliciting input of execution parameters for managing execution of the training exercise. The method further includes receiving from the second interface execution parameters entered by a user and modifying execution of the training exercise as defined by the execution parameters. The method further includes storing performance data associated with performance of participants during execution of the training exercise and providing a third interface that provides a summary of the performance data.

In another embodiment of the present invention, a computer program product comprising a computer usable medium embodying computer usable program code for managing a computer simulation is disclosed. The computer program product comprises computer usable program code for executing the training exercise defined by the initialization parameters and providing a second interface for soliciting input of execution parameters for managing execution of the training exercise. The computer program product further comprises computer usable program code for receiving from the second interface execution parameters entered by a user and modifying execution of the training exercise as defined by the execution parameters. The computer program product further comprises computer usable program code for storing performance data associated with performance of participants during execution of the training exercise and providing a third interface that provides a summary of the performance data.

In another embodiment of the present invention, for providing event information for a computer simulation is disclosed. The method includes receiving location information for each participant of the computer simulation being controlled by a program logic managed by an individual so as to simulate human actions and receiving location information for each participant being controlled by an individual executing human actions that are captured. The method further includes receiving a map representing an area in which the participants of the computer simulation are located. The method further includes determining a location of each participant on the map and providing an interface that displays the map and the location of each participant of the computer simulation on the map.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is a block diagram showing the system architecture of a simulation system in accordance with an embodiment of the present invention.

FIG. 2 is an illustration showing one implementation of the simulation system of FIG. 1.

FIG. 3 is a block diagram showing the system architecture of a simulation system in one embodiment of the present invention.

FIG. 4 is an illustration showing one implementation of the simulation system of FIG. 3.

FIG. 5 is a block diagram showing the components of a simulation management system in accordance with an embodiment of the present invention.

FIG. 6 is a flow chart showing the control flow of components of a simulation management system in accordance with an embodiment of the present invention.

FIG. 7 is an illustration of an interface used to provided event information and situational awareness data during the execution of a simulation, in accordance with an embodiment of the present invention.

### DETAILED DESCRIPTION

The present invention provides a method, computer system and computer program product for managing various aspects of the life cycle of a computer simulation. The present invention provides a single source or interface for: 1) planning, designing and developing a training exercise for a computer simulation, 2) delivering or executing the training exercise, 3) managing the execution of the training exercise and 4) performing an evaluation of the executed training exercise after completion via after-action reports. The present invention is advantageous as it eliminates the need for obtaining and utilizing separate software for performing separate tasks related to a computer simulation life cycle. The present invention provides a single solution by providing a software package that unifies the automated tasks for managing the life cycle of a computer simulation. This feature reduces or eliminates problems associated with compatibility between programs and porting data from one program to another. This feature further eliminates the need to obtain and purchase disparate software programs and the need to learn to use different interfaces.

The features of the present invention are further advantageous as they allow for the involvement of participants in the simulation that may be controlled by: 1) an individual interacting with a computer so as to mimic or simulate human actions within the simulation, 2) an individual interacting with the real world such that the individual's actions in the real world are translated into human actions within the simulation via capture of the individual's movement, location, etc. or 3) a computer program executing within the simulation. As such, simulations that are virtual, semi-virtual and combinations of the two can be supported at the same time. This is advantageous as it allows for computer simulations of various types to operate simultaneously, thereby eliminating the need to port all computer simulations to the same type.

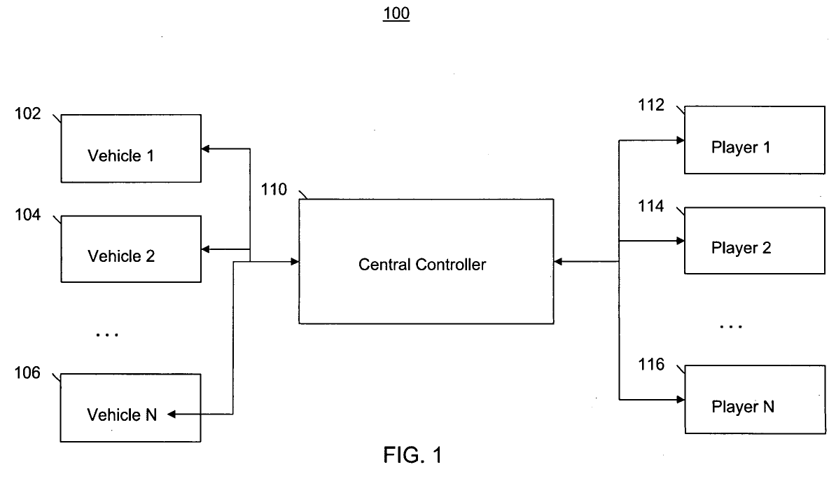

FIG. 1 is a block diagram showing the system architecture of a simulation system 100 in accordance with an embodiment of the present invention. The simulation system 100 includes a variety of participants, including a plurality of vehicles 102-106, such as tanks, jeeps, armored personnel carriers and heavy hauling equipment and a plurality of individuals 112-116, representing soldiers and other individuals participating in the simulation. A participant in the simulation system 100 may be controlled by an individual interacting with a computer so as to mimic or simulate human actions within the simulation. Alternatively, a participant in the simulation system 100 may be controlled by an individual interacting with the real world such that the individual's actions in the real world are translated into human actions within the simulation via capture of the individual's movement, location, etc. In another alternative, a participant in the simulation system 100 may be controlled by a computer program executing within the simulation.

Each vehicle 102-106 and individual 112-116 in the simulation system 100 can interact with each other as well as with the central controller 110, which controls various aspects of the simulation and stores simulation information. The central controller 110 may include a computer network capable of tracking multiple participating entities, controlling various aspects of game play and storing various types of information regarding the simulation.

In embodiments wherein certain participants are controlled by an individual interacting with the real world such that the individual's actions in the real world are translated into human actions within the simulation, the central controller 110 may also include a radio communication system. In this embodiment, each individual participant can be outfitted with a mobile simulation unit that can receive and transmit signals, infrared (IR) signals and radio frequency (RF) signals, for example, such as in the MILES simulation system used by the U.S. military for realistic combat training. The central controller 110 may further be able to communicate with the participants via RF and IR signals. IR signals are typically used to indicate to a mobile simulation unit that the receiver has been injured, killed or otherwise compromised. RF signals are typically used to send a message or other information among mobile simulation units and/or the central controller 110. RF signals can be further used to exchange information among mobile simulation units during a simulation. The central controller 110 may keep up to date on the locations and status of each participant in the simulation via the aforementioned RF and IR signals.

It should be noted that although FIG. 1 shows only three vehicles 102-106 and three individuals 102-106, the simulation system 100 may support high numbers (sometimes thousands) of entities participating in the simulation.

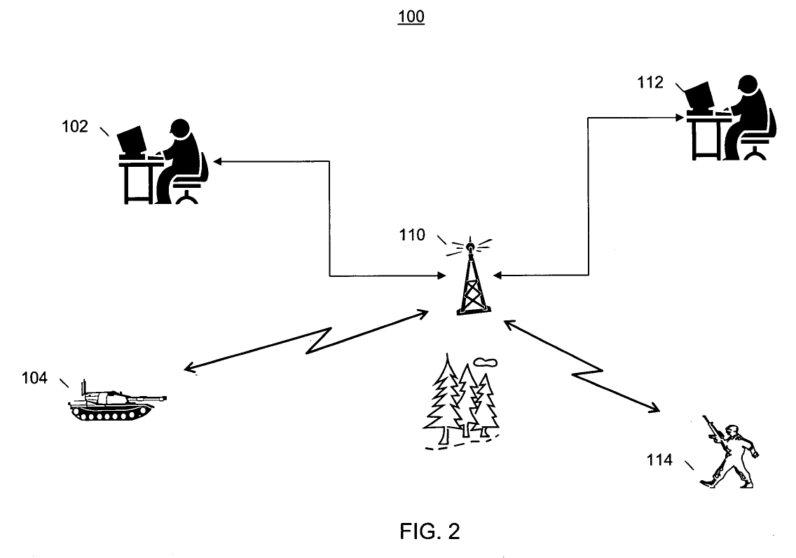

FIG. 2 is an illustration showing one implementation of the simulation system 100 of FIG. 1. The implementation shown in FIG. 2 of the simulation system 100 includes the vehicles 102, 104 (tanks in this example) and individuals 112, 114 (soldiers on foot) participating in the simulation. FIG. 2 further shows the central controller 110, which controls various aspects of the simulation. The implementation of FIG. 2 shows that the vehicle 102 and the soldier 112 are both controlled by a separate individual interacting with a computer so as to emulate human actions in the simulation. The implementation further shows that the vehicle 104 and the soldier 114 are both controlled by an individual interacting with the real world such that the individual's actions in the real world are translated into human actions within the simulation. In one embodiment of the present invention, the individuals controlling vehicle 102 and soldier 112 communicate with the central controller 110 via a wired connection while the individuals controlling vehicle 104 and soldier 114 communicate with the central controller 100 via RF communications.

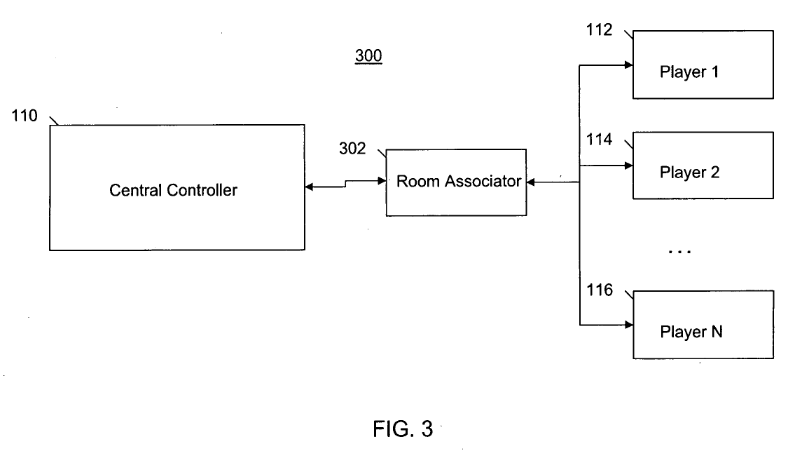

FIG. 3 is a block diagram showing the system architecture of a simulation system 300 in one embodiment of the present invention. The simulation system 300 includes a plurality of individuals 112-116 (identical to the individuals of system 100 in FIG. 1), representing soldiers and other individuals participating in the simulation. Each individual 112-116 in the military simulation system 300 can interact with each other as well as with the central controller 110, which controls various aspects of the simulation.

Note that the radio-controlled military simulation system 300 differs from the simulation system 100 of FIG. 1 by the inclusion of the room associator 302 between the central controller 110 and the players 112-116. The room associator 302 acts like a relay for simulation data exchanged during the execution of a simulation. Whereas, in simulation system 100 players 112-116 and central controller 110 must transmit messages directly between one another, in the simulation system 300 players 112-116 and central controller 110 transmit messages between one another via a room associator 302. This allows for the exchange of simulation data between players 112-116 within a building and the central controller 110. Further, the room associator 302 allows for better and more accurate communication among players 112-116 within a room in an edifice. Lastly, the room associator 302 allows for increased communication among between players within and without a room in an edifice.

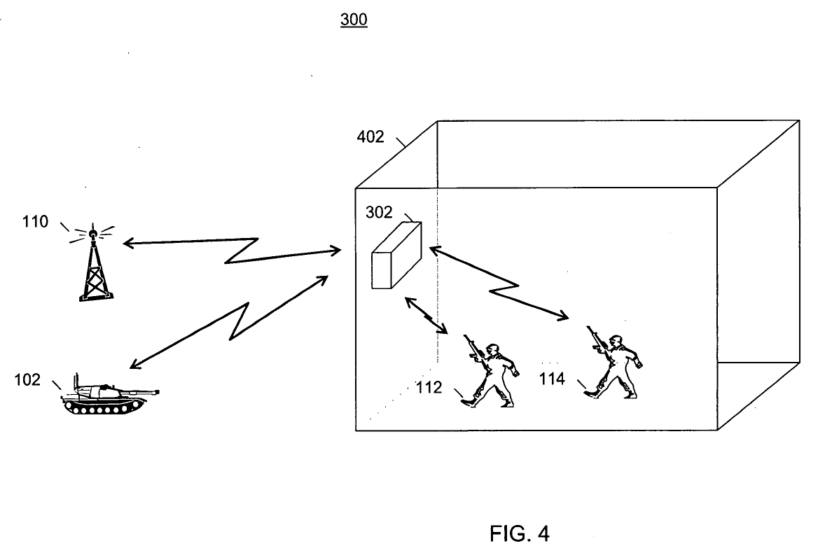

FIG. 4 is an illustration showing one implementation of the simulation system 300 of FIG. 3. The simulation system 300 includes individuals 112, 114 (soldiers on foot) within a building 402, and at least one vehicle 102 (a tank). Each individual 112, 114 and vehicle 102 in the simulation system 300 can interact with each other as well as with the central controller 110, which controls various aspects of the simulation. FIG. 4 shows the room associator 302 mounted on the edifice 402 and acting as a relay for simulation data between the central controller 110 and the players 112-114, as well as among the players themselves.

The room associator 302 may communicate with the central controller 110 via RF signals and communicate with players 112-114 via RF and IR signals. The room associator 302 may further send commands to players 112-114. The central controller 110 may send commands to the room associator 302 to perform certain tasks, such as transmitting updated player information, transmitting simulation updated event data and taking and transmitting video or still images or sound recordings of simulation events. The room associator 302 may further log simulation event data such as: 1) RF messages from players indicating status such as alive, dead or injured, 2) IR events from players including the firing of simulated shots within or without a room, 3) still images taken of a simulation event, 4) sound recordings taken of a simulation event. Additionally, the room associator 302 may transmit the logged data to the central controller 110 over an RF signal only when the event occurs.

In additional embodiments of the present invention, the room associator 302 may be used in a variety of ways, including: to simulate a wall breaching simulation event, to send simulation commands such as a reset command, to simulate barrier strength of the building 402, to simulate target fire-back within the building 402, to reduce laser ricochets within the building 402, to provide automatic backlighting of simulation events and to simulate an area weapon simulation event. In further embodiments of the present invention, a plurality of room associators in separate rooms may be used to transmit messages between one another via RF signals to propagate large explosions or area weapons or may be used to locate players and store and/or transmit their locations.

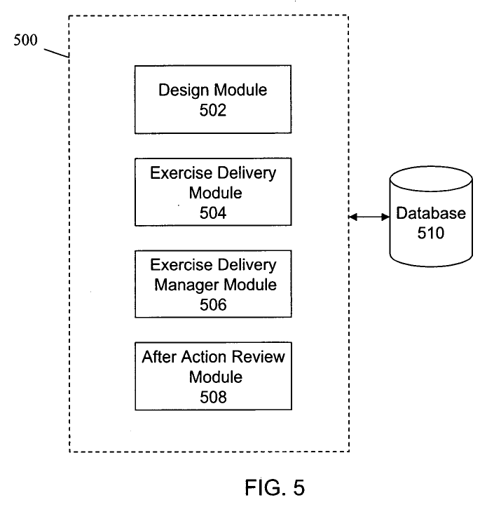

FIG. 5 is a block diagram showing the components of a simulation management system 500 in accordance with an embodiment of the present invention. The simulation management system 500 provides the tools for managing various aspects of the entire life cycle of a computer simulation. The simulation management system 500 provides a design module 502 for planning, designing and developing a training exercise for a computer simulation. The design module 502 can provide an interface, such as a web browser running a multimedia program such as Flash, to one or more administrators or designers tasked with designing a training exercise. The interface would be used by the administrator to enter information that would define a training exercise or a training scenario.

A training exercise can include training exercise attributes such as: a title, a team lead, a location, a date, a short description, a narrative description, a mission, a purpose, a type, a status, a clock and a classification level. A scenario is an outline of an hypothesized chain of events. Examples of scenarios that can be constructed and stored in design module 502 include: biological events, aerosol anthrax event, food contamination event, foreign animal disease event, pandemic influenza event, plague, chemical agent event, blister agent event, chlorine tank explosion, nerve agent event, toxic industrial chemical event, explosive event, improvised explosive device event, natural disasters, major earthquakes, major hurricanes, nuclear event, improvised nuclear device event, agricultural event, cyber event, pollution event, radiological event, radiological dispersal device event.

The administrator can further utilize the design module 503 to define various data that defines a training exercise or scenario. This includes skins, which provide themes, backgrounds and logos for the training exercise. Other data that defines a training exercise includes actions (which refer to messages, decisions, directives, movements and tasks) that occur during the course of execution of a training exercise. Actions of this type may occur in response to certain stimuli, such as in an inference engine implementation wherein rules are provided by the administrator so as to define when an action is executed. A rule defines a set of preconditions that must be met in order for an action to be executed. Thus, rules can be set up to define the execution of actions in response to certain behavior or decisions of the participants of the computer simulation.

Other data that defines a training exercise includes roles, which define the role played by a participant or group of participants in the training exercise. Examples of roles include: Customs and Border Patrol, Immigration, Dept. of Homeland Security, Army, Navy, Air Force, Marines, Coast Guard. Other data that defines a training exercise includes text, images, audio, video, chat message and emails that are transmitted and received during the course of execution of a training exercise.

The simulation management system 500 further provides an exercise delivery module 504 for delivering or executing the training exercise. The exercise delivery module 504 can provide an interface, such as a web browser running a multimedia program such as Flash, to one or more administrators or designers for delivering a training exercise to participants and/or to allow a participant or viewer to observe a training exercise. The interface would be used by the administrator to view information pertaining to the execution of a training exercise.

The exercise delivery module 504 can display various types of information pertaining to the execution of a training exercise such as: 1) an introduction, which provides objectives of the training exercise and related information, 2) communications information, such as text representations of text communications, email communications and radio communications, 3) a map that represents an area in which the computer simulation is taking place, 4) locations of various participants and observers of the computer simulation, as well as their designations (such as friendly or enemy), 5) various media, such as audio, video, text and images that pertain to the execution of the training exercise, 6) web cam video streams that may record incidents or events taking place in the simulation, 7) a level display which depicts the current level of the training exercise, 8) an event log that provides text explaining the occurrence of events, and 9) a scenarios status display that depicts the current status of the training exercise. An event can be associated with various data, such as a player ID, date, time, location, event type (fratricide, firing, lethality, etc.), description, weapon, ammo type, ammo fired, ammo remaining, etc.

Note that the various types of information displayed by the exercise delivery module 504 includes information that must be received and processed before displayed. For example, in one embodiment, the exercise delivery module selects a map for display in the interface and subsequently receives location information for one or more participants of the computer simulation. In this embodiment, the exercise delivery module 504 position of the participant in the map and thus displays a symbol in the map representing the participant.

The simulation management system 500 further provides an exercise delivery manager module 506 for managing the training exercise during execution. The exercise delivery manager module 506 can provide an interface, such as a web browser running a multimedia program such as Flash, to one or more administrators or designers for managing the execution of the training exercise. The interface would be used by the administrator to enter information pertaining to the management of the execution of the training exercise.

The simulation management system 500 further provides an after-action review module 508 for performing an evaluation of the executed training exercise after completion via after-actions report. The after-action review module 508 can provide an interface, such as a web browser running a multimedia program such as Flash, to one or more administrators for managing the creation of reports for evaluating the training exercise. The interface would be used by the administrator to enter information pertaining to the customization of reports for evaluating the training exercise. The simulation management system 500 further includes a database 510 for storing various data that is generated by the modules 502-508, as well as by the execution of a training exercise.

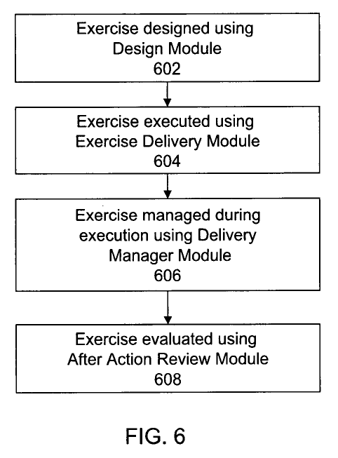

FIG. 6 is a flow chart showing the control flow of components of the simulation management system 500 in accordance with an embodiment of the present invention. In a first step 602, the simulation management system 500 provides a design module 502 that is used by an administrator or administrators for planning, designing and developing a training exercise for a computer simulation. Then, in step 604, an exercise delivery module 504 is utilized to deliver or execute the training exercise. In step 606, an exercise delivery manager module 506 is provided for managing the execution of the training exercise. Finally, in step 608, an after-action review module 508 is utilized for performing a customized evaluation of the executed training exercise after completion via after-action reports.

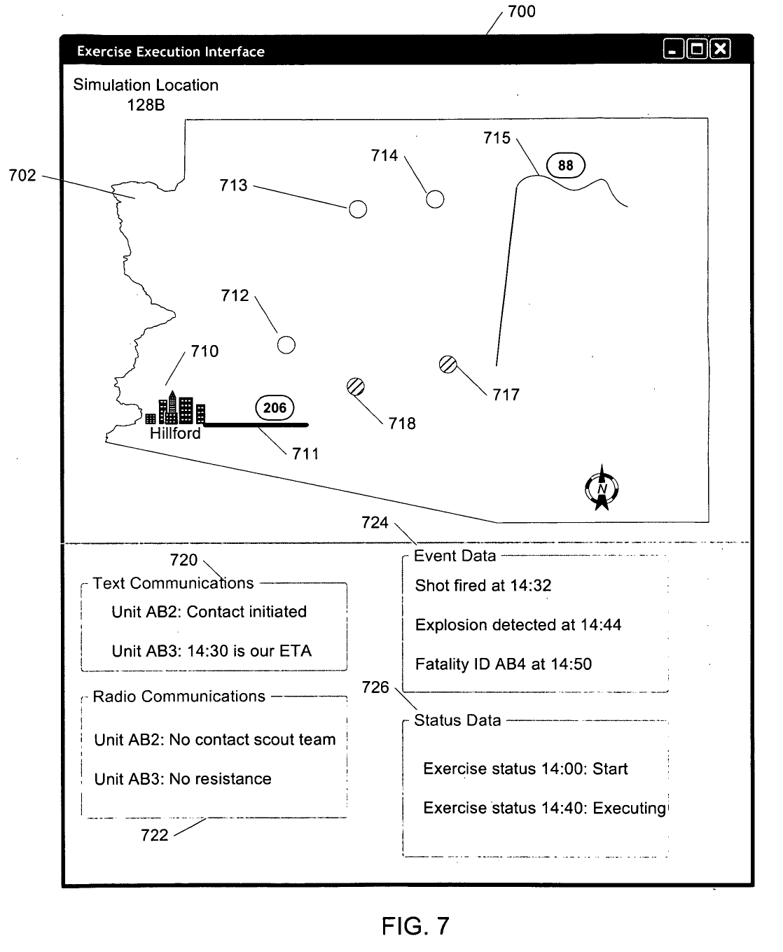

FIG. 7 is an illustration of an interface 700 used to provided event information and situational awareness data during the execution of a simulation in step 604 of FIG. 6 above, in accordance with an embodiment of the present invention. FIG. 7 shows that the user interface 700 is a conventional web browser. Interface 700 may be displayed on a computer, mobile telephone or mobile computer. Interface 700 may be one component of the exercise delivery module 504 that is provided to one or more participants or administrators of the computer simulation over a network.

FIG. 7 shows that interface 700 displays a map 306 that represents the location of the participants of the simulation, wherein it be the physical location of participants executing human actions that are capture or the virtual location of individuals interacting with a computer program that simulations human actions. Interface 700 displays roads, 711 and 715 and city or town 710. Interface 700 further displays the location of friendly units or individuals 712, 713 and 714, as well as the location of enemy units or individuals 717, 718.

FIG. 7 further shows that interface 700 displays various groups of data, such as text communications 720 and radio communications 722. Interface 700 also displays event data 724 and simulation status information 726.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method for managing a computer simulation, comprising:
providing an interface for soliciting input of initialization parameters for generating a training exercise;
receiving from the interface initialization parameters entered by a user;
executing the training exercise defined by the initialization parameters;
providing a second interface for soliciting input of execution parameters for managing execution of the training exercise;
receiving from the second interface execution parameters entered by a user;
modifying execution of the training exercise as defined by the execution parameters;
storing performance data associated with performance of participants during execution of the training exercise; and
providing a third interface that provides a summary of the performance data.

2. The method of claim 1, wherein the step of providing the third interface comprises:
providing the third interface for soliciting input of display parameters for customizing display of performance data;
receiving from the third interface display parameters entered by a user; and
displaying the performance data as defined by the display parameters.

3. The method of claim 2, wherein the step of providing an interface comprises providing a web browser executing a program logic that solicits input of initialization parameters.

4. The method of claim 3, wherein the step of providing a second interface comprises providing a web browser executing a program logic that solicits input of execution parameters.

5. The method of claim 4, wherein the step of providing a third interface comprises providing a web browser executing a program logic that solicits input of display parameters.

6. The method of claim 2, wherein the step of providing a second interface further comprises:
providing a web browser executing a program logic that displays a map and a location of each participant of the computer simulation on the map.

7. The method of claim 6, further comprising:
receiving location information for each participant being controlled by a program logic managed by an individual so as to simulate human actions;
receiving location information for each participant being controlled by an individual executing human actions that are captured; and
determining a location of each participant on the map.

8. A computer program product comprising a computer usable medium embodying computer usable program code for managing a computer simulation, the computer program product comprising:
computer usable program code for providing an interface for soliciting input of initialization parameters for generating a training exercise;
computer usable program code for receiving from the interface initialization parameters entered by a user;
computer usable program code for executing the training exercise defined by the initialization parameters;
computer usable program code for providing a second interface for soliciting input of execution parameters for managing execution of the training exercise;
computer usable program code for receiving from the second interface execution parameters entered by a user;
computer usable program code for modifying execution of the training exercise as defined by the execution parameters;
computer usable program code for storing performance data associated with performance of participants during execution of the training exercise; and
computer usable program code for providing a third interface that provides a summary of the performance data.

9. The computer program product of claim 8, wherein the computer usable program code for providing the third interface comprises:
computer usable program code for providing the third interface for soliciting input of display parameters for customizing display of performance data;
computer usable program code for receiving from the third interface display parameters entered by a user; and
computer usable program code for displaying the performance data as defined by the display parameters.

10. The computer program product of claim 9, wherein the computer usable program code for providing an interface comprises computer usable program code for providing a web browser executing a program logic that solicits input of initialization parameters.

11. The computer program product of claim 10, wherein the computer usable program code for providing a second interface comprises computer usable program code for providing a web browser executing a program logic that solicits input of execution parameters.

12. The computer program product of claim 11, wherein the computer usable program code for providing a third interface comprises computer usable program code for providing a web browser executing a program logic that solicits input of display parameters.

13. The computer program product of claim 9, wherein the computer usable program code for providing a second interface further comprises:
computer usable program code for providing a web browser executing a program logic that displays a map and a location of each participant of the computer simulation on the map.

14. The computer program product of claim 13, further comprising:
computer usable program code for receiving location information for each participant being controlled by a program logic managed by an individual so as to simulate human actions;
computer usable program code for receiving location information for each participant being controlled by an individual executing human actions that are captured; and
computer usable program code for determining a location of each participant on the map.

15. A method for providing event information for a computer simulation, comprising:
receiving location information for each participant of the computer simulation being controlled by a program logic managed by an individual so as to simulate human actions;
receiving location information for each participant being controlled by an individual executing human actions that are captured;
receiving a map representing an area in which the participants of the computer simulation are located;
determining a location of each participant on the map; and
providing an interface that displays the map and the location of each participant of the computer simulation on the map.

16. The method of claim 15, wherein the step of providing an interface comprises:
providing a web browser executing a program logic that displays a map and a location of each participant of the computer simulation on the map.

17. The method of claim 16, wherein the step of providing an interface further comprises:
receiving event occurrence data including a location of the event occurrence; and
displaying the event occurrence data on the map.

18. The method of claim 16, wherein the step of providing an interface further comprises:
receiving event occurrence data including a location of the event occurrence; and
displaying the event occurrence data on the map.

19. The method of claim 16, wherein the step of providing an interface further comprises:
receiving video from a location on the map; and
displaying the video data in the interface.
